(19) United States
(12) Patent Application Publication
(10) Pub. No.: US 2019/0343105 A1
(43) Pub. Date: Nov. 14, 2019

(54) SUPPORT AND ANCHOR MEMBER FOR FISHING RODS

(71) Applicant: Brian Best, Panama City Beach, FL (US)

(72) Inventor: Brian Best, Panama City Beach, FL (US)

(21) Appl. No.: 16/407,471

(22) Filed: May 9, 2019

Related U.S. Application Data
(60) Provisional application No. 62/670,293, filed on May 11, 2018.
(60) Provisional application No. 62/730,325, filed on Sep. 12, 2018.

(51) Int. Cl. A01K 97/10

(52) U.S. Cl. CPC A01K 97/10; A01K 87/04

(57) ABSTRACT

A fishing rod support device is provided. The device is operable to receive and support a fishing rod and at least one additional article. The device can be anchored or secured in the ground. Devices of the present disclosure are well suited for shore fishing in salt and fresh water, and serve to reduce the number of devices and accessories needed for such activities.

### CROSS-REFERENCE TO RELATED APPLICATIONS

This application claims priority and benefits under 35 U.S.C. § 119(e) to U.S. Provisional Patent Application Ser. No. 62/670,293 filed May 11, 2018 and entitled “Support and Anchor Member for Fishing Rods,” and to U.S. Provisional Patent Application Ser. No. 62/730,325 filed Sep. 12, 2018 and entitled “Support and Anchor Member for Fishing Rods,” which are each incorporated herein in their entirety by reference.

### FIELD OF THE INVENTION

The present disclosure relates to devices and accessories for holding and stabilizing fishing rods and similar objects. In some embodiments, the present disclosure provides a holder that is operable to receive and support a fishing rod and an additional item, such as an umbrella. Embodiments of the present disclosure are useful in, but not limited to, fresh and salt water fishing applications.

### BACKGROUND

Various devices are known for supporting fishing rods in an unattended or partially attended state. At least some of these devices are simple hollow tubes that are impaled into soil or sand and are capable of receiving an elongate handle of a fishing rod. Similarly, shade and umbrella devices are provided with an elongate portion or spike that may be used to anchor the device into the ground. These devices generally accommodate a single item or accessory, and are not known to provide or contemplate an adjustment feature for a least one of the accessories.

### SUMMARY

Accordingly, there has been a long felt and unmet need to provide a combined fishing rod holder and umbrella support. In various embodiments, a fishing rod holder is provided with a first portion that is operable to receive a fishing rod and a second portion that is operable to receive and support an umbrella or similar device. In some embodiments, the first portion comprises an adjustable portion such that at least one of the angle and the orientation of the fishing rod can be adjusted.

It is an object of the present disclosure to provide an anchored and adjustable fishing rod holder and support device. It is also an object of the present disclosure to provide a multi-functional device to receive and support a fishing rod and related accessories including, but not limited to a beach umbrella. Yet another object of the present disclosure is the minimization of the devices and accessories needed to support various objects when fishing from shorelines.

In one embodiment, a fishing rod holder and support device is provided that comprises a main body portion having an upper end, a lower end, and a length extending therebetween. The upper end comprises an aperture for receiving at least one of a fishing rod and an adjustable fishing rod holder.

The lower end comprises a base plate. The base plate is optionally configured to rotate relative to the anchor member. In one embodiment, the base plate includes a plurality of projections which extend generally perpendicular to main body portion.

An anchor member extends from the base plate and the anchor member is operable to penetrate a ground surface comprising at least one of soil and sand. In one embodiment, the anchor member comprises two or more anchor members extending from the base plate.

A secondary support member is provided that extends at an angle relative to the main body portion. The secondary support member is operable to receive an elongate device. The elongate device can be a shaft or mast of a beach umbrella. The secondary support member can include a bore to receive the elongate device. The secondary support member can include a retention element to releasably secure the elongate device to the fishing rod holder. In one embodiment, apertures are provide through the secondary support member to pin the elongate device in the bore. Optionally, the secondary support member can be affixed to the base plate and the main body portion at an angle of between about 15° and 60°. In one embodiment, an angle iron with a first end is fixed to the main body portion and a second end of the angle iron is fixed to the secondary support member.

The adjustable fishing rod holder can have a cylindrical body, a bore extending through the body, and a slot to engage the fishing rod formed through an upper end of the cylindrical body, the slot including a longitudinal trunk and a transverse base. In one embodiment, the adjustable fishing rod holder further includes an arcuate plate extending from the cylindrical body. The arcuate plate may include a plurality of teeth configured to engage a toothed structure of a clamping element affixed to the upper end of the main body portion.

At least one storage compartment is provided and mounted to the main body portion. The at least one storage compartment being operable to receive at least one of a beverage container, an electronic device, and a personal article.

The main body portion is optionally configured to facilitate rotation of the fishing rod or the adjustable fishing rod holder. In one embodiment, the main body portion comprises a plurality of apertures formed transverse to the length.

Another aspect of the present disclosure is a holder for a fishing rod and an umbrella. The holder generally includes, but is not limited to: (1) a base plate; (2) a first anchor extending downwardly away from the base plate; (3) a main body extending upwardly from the base plate, the main body including an upper end with a mounting plate; (4) a clamping member with a flange secured to the mounting plate, a projection extending upwardly from the flange and including a planar surface, an aperture extending through the planar surface, and a plurality of teeth extending radially around the aperture; (5) a rod holder including a cylindrical body, a bore extending through the cylindrical body, a slot to engage the fishing rod formed through an upper end of the cylindrical body, and an arcuate plate extending from the cylindrical body, the arcuate plate including a hole and a toothed structure formed around the hole, the rod holder being rotatably secured to the clamping member by a bolt that extends through the plate hole and the projection aperture such that the teeth engage the toothed structure; and (6) a secondary member affixed to the base plate and oriented at an oblique angle to the main body, the secondary member including an upper end with an opening to a bore configured to receive a shaft of the umbrella.

The holder can further comprise an accessory holder affixed to the main body. The accessory holder can be configured to receive at least one of a beverage container and an electronic device.

In one embodiment, a user interface is connected to the holder proximate to the base plate. The user interface is configured to receive a force from the user, such as to drive the first anchor into the ground or sand. The user interface generally includes one or more of a first projection, a second projection opposite the first projection, and a third projection. The projections can be oriented approximately perpendicular to the main body. Additionally, or alternatively, the projections of the user interface may be generally planar. Optionally, the first anchor extends downwardly from the first projection. In one embodiment, a second anchor can extend downwardly from at least one of the second and third projections. Additionally, the user interface can be configured to rotate relative to the base plate and the main body.

The clamping member can secured to the mounting plate by at least two fasteners that extend through apertures of the clamping member flange and the mounting plate. In one embodiment, the cylindrical body of the rod holder can be oriented at an angle of 0° and approximately 80° relative to the main body. Additionally, the oblique angle between the secondary member and the main body can optionally be between approximately 20° and approximately 40°.

In some embodiments, methods of forming a fishing rod holder and support device are provided. In one embodiment, for example, a method is provided that comprises providing an elongate pipe member, welding a plate to the elongate pipe member, welding a stake to the plate, providing a pole, welding a top plate to the top of the pole, mounting a device holder to the top of the plate, and mounting at least one accessory holding device to an elongate portion of the pole.

This Summary is neither intended or should it be construed as being representative of the full extent and scope of the present invention. The present invention is set forth in various levels of detail and the Summary as well as in the attached drawings and in the detailed description of the invention and no limitation as to the scope of the present invention is intended by either the inclusion or non-inclusion of elements, components, etc. in the Summary. Additional aspects of the present invention will become more readily apparent from the detailed description, particularly when taken together with the drawings.

### BRIEF DESCRIPTION OF THE DRAWINGS

The accompanying drawings are incorporated herein and constitute a part of the specification, illustrate various embodiments of numerous inventions and together with the general description of the invention given provide the detailed description, and the drawings serve to explain the principles of these embodiments.

FIG. 1 is a front elevation view of a rod holder and support according to one embodiment of the present disclosure.

FIG. 2 is an elevation view of an adjustable rod holder and support member according to one embodiment of the present disclosure.

FIG. 3 is a perspective view of a rod holder and support device according to one embodiment of the present disclosure and illustrating a fishing rod and an umbrella supported by the rod holder and support device.

FIG. 4 is a perspective view of a rod holder and support device according to the embodiment of FIG. 3.

FIG. 5 is a perspective view of the rod holder and support of the embodiment of FIG. 3.

FIG. 6 is a perspective view of an adjustable rod holder and support according to one embodiment of the present disclosure.

FIG. 7 is a perspective view of a portion of the rod holder and support of FIG. 6.

FIG. 8 is a perspective view of a portion of the rod holder and support of FIG. 6.

FIG. 9 is a perspective view of a portion of a rod holder and support device of another embodiment of the present disclosure.

FIG. 10 is another perspective view of the rod holder and support device of FIG. 9.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

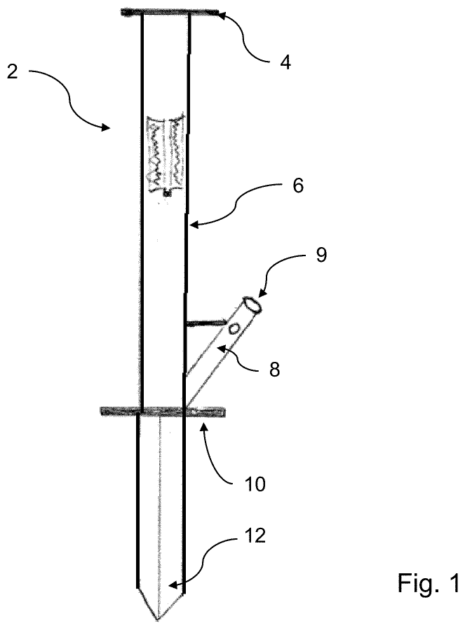

FIG. 1 is a front elevation view of a rod holder and support device 2 according to one embodiment of the present disclosure. As shown, the rod holder and support device 2 comprises a mounting plate 4 provided at an upper end of an elongate main body portion 6. A second end of the main body portion 6 is provided at an opposing end relative to the mounting plate, and the second end comprises a base plate 10. An anchor member 12 extends from the base plate. In some embodiments, the anchor member 12 comprises a spike that is substantially coaxial with the main body portion 6.

A secondary support member 8 extends from the main body portion 6 at an angle. The secondary support member 8 can be oriented transverse to the main body portion at an angle of between about 10° and 80°. Optionally, the angle between the secondary support member 8 and the main body portion 6 can be adjusted by a user.

In some embodiments, the secondary support member 8 comprises a pipe that is hollow or semi-hollow and defining a bore 9 operable to receive an umbrella, for example. Although various embodiments of the present disclosure contemplate the provision of elongate umbrella rods in order to receive and support an umbrella, it will be recognized that the present invention is not limited to umbrellas. Indeed, any number of objects and accessories may be provided within and supported by embodiments of the present disclosure. For example, the secondary support member 8 is contemplated as receiving, and is operable to receive, a fishing rod, a flag, a lighting element, an additional anchor member, and various similar devices.

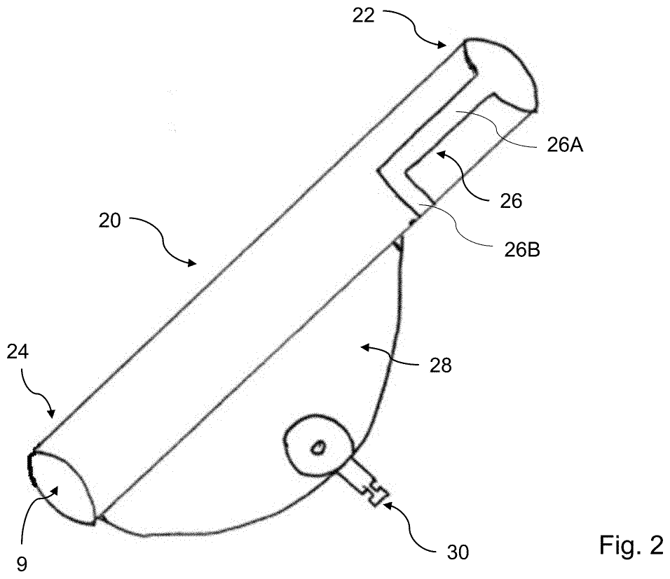

FIG. 2 is a perspective view of an adjustable rod holder 20 according to one embodiment of the present disclosure. As shown, the rod holder 20 generally comprises a first end 22 and a second end 24. The first end 22 comprises a slot 26. The slot is operable to selectively receive a portion of a fishing rod. As shown in FIG. 2, some embodiments of the present disclosure contemplate that the slot 26 comprises a L-shaped slot to secure a fishing rod. The L-shaped slot 26 generally includes a trunk 26A and a base 26B. The trunk 26A can extend approximately parallel to a longitudinal axis of the adjustable rod holder. The base 26B is oriented transverse to the truck 26A, or approximately perpendicular to the longitudinal axis.

A fishing rod may be inserted into an internal portion of the holder 20 and the longitudinal trunk 26A of the slot 26. In order to secure the fishing rod, the rod is rotated into the transverse base 26B of the L-shaped slot and is thereby held in place. A reel or reel-mount, for example, may be provided in the slot 26 to secure the rod and reel. In one embodiment, the transverse base 26B can be oriented toward the first end 22. In this manner, the fishing rod can be maintained secured to adjustable rod holder if the fishing rod is pulled in the direction of the second end 22.

An arcuate plate 28 is also provided that is secured (e.g. welded) to the main body portion of the rod holder 20. The arcuate plate 28 of FIG. 2 comprises a flat plate that is approximately a half-circle. A clamping and securing member 30 is provided that is operable to selectively secure the rod holder 20 at a plurality of different angular positions relative to a rod holder 2 (such as generally illustrated in FIG. 1, for example). The securing member 30 is also operable to be at least partially inserted into the main body portion of a rod holder.

In some embodiments, a rod support member is provided that is operable to receive a pre-existing adjustable rod holder. For example, in some embodiments, the main body portion 6 of the rod holder and support device 2 comprises an aperture or similar receiving portion at one end of the main body portion that is operable to selectively receive a rod holder including, but not limited to, the rod holders shown and described in U.S. Pat. No. 8,024,886 to Sutherland et al., which is hereby incorporated by reference in its entirety.

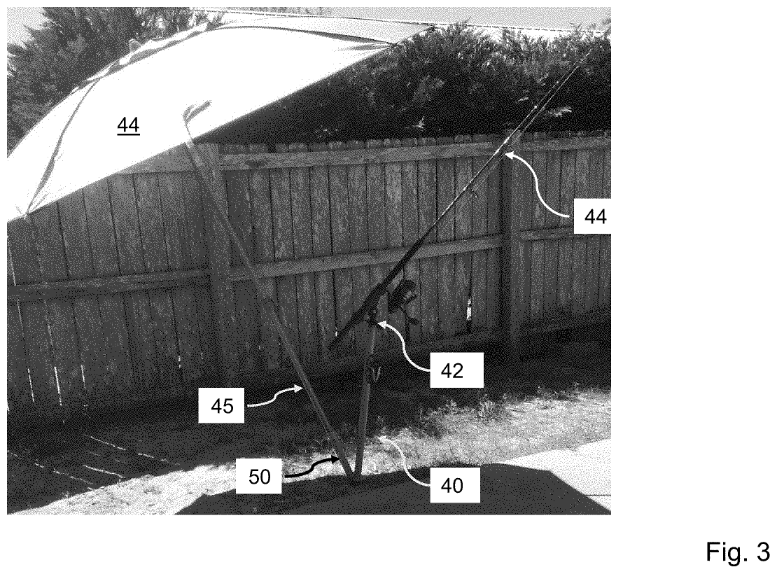

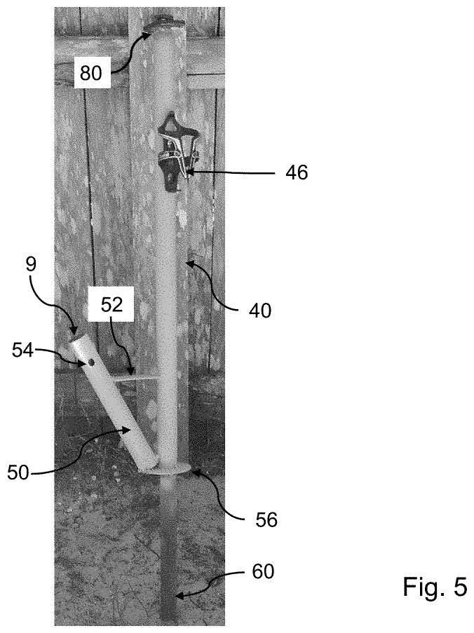

FIGS. 3-5 provide various views of a fishing rod holder and support device according to one embodiment of the present disclosure. As shown, the fishing rod holder and support device comprises a main body portion 40. The main body portion 40 is operable to receive an adjustable rod holder 42 at an upper end of the main body portion. The adjustable rod holder 42 can be secured to the main body portion 40 by various means. In some embodiments, the adjustable rod holder 42 is simply inserted into an internal portion of the main body portion 40. The adjustable rod holder 42 is operable to receive a fishing rod 44 such that the fishing rod can be provided in various different angles relative to the ground (for example) and provided in a position wherein the rod is operable to be used in shore fishing applications (i.e. wherein a user does not need to hold or be in contact with the rod at all times).

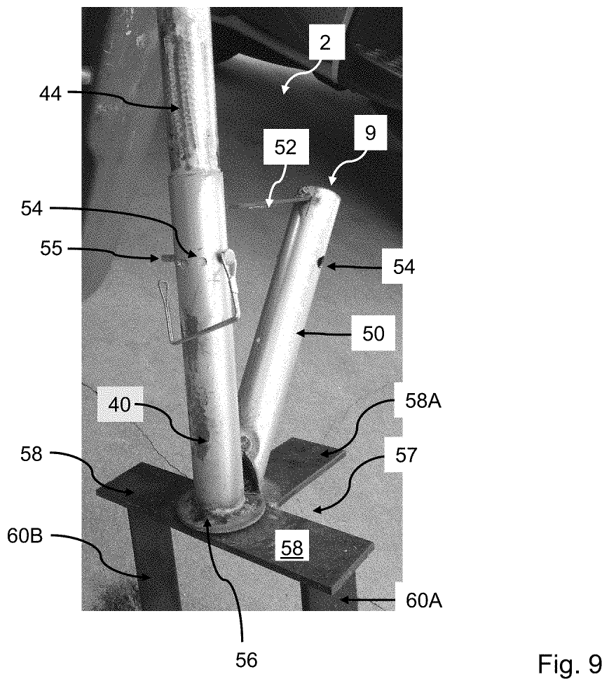

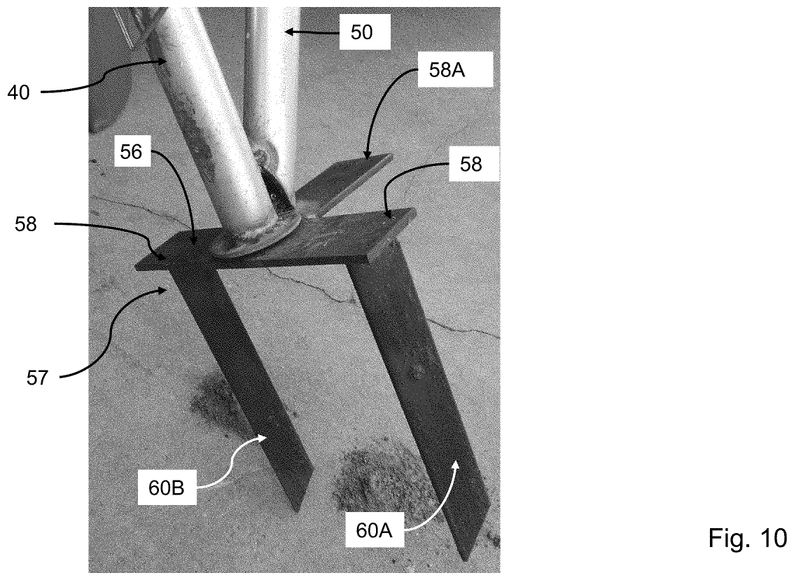

A second end of the main body portion 40 comprises a base plate 56, and an anchor 60 extending downwardly therefrom. The base plate 56 comprises a user-interface wherein a user may apply force to the base plate to insert the anchor 60 into the ground, and also serves as a stop or limiter to prevent the main body portion 40 from being inserted into the ground. In some embodiments, the anchor 60 comprises a metal spike that is substantially coaxial with the main body portion 40. Alternative arrangements, however, are contemplated for the anchor member. For example, a plurality of downwardly extending members may be provided as anchor and/or the anchor member may extend at one or more angles relative to the main body portion, such as generally illustrated in FIGS. 9-10. The base plate 56 may be provided as a circular or square base plate, but no limitation with respect to the geometric shape of the base plate is provided.

The fishing rod holder and support device further comprises a secondary support member 50 that extends at an angle relative to the main body portion 40. The secondary support member 50 is preferably welded to the base plate 56 and/or the main body portion 40. An angle iron 52 or similar connecting member is provided to provide structural support to the secondary support member 50. The secondary support member 50 generally comprises a pipe that is operable to receive an umbrella 44 or similar device. A bore 9 extends at least to an upper end of the secondary support member 50.

An aperture 54 is provided in the secondary support member 50. The aperture is operable to receive a pin or similar connector to engage an umbrella or similar device. More specifically, a hole in an umbrella shaft 45 can be aligned with the aperture 54 and a pin can then be inserted through the aperture into umbrella hole to secure the umbrella to the secondary support member 50.

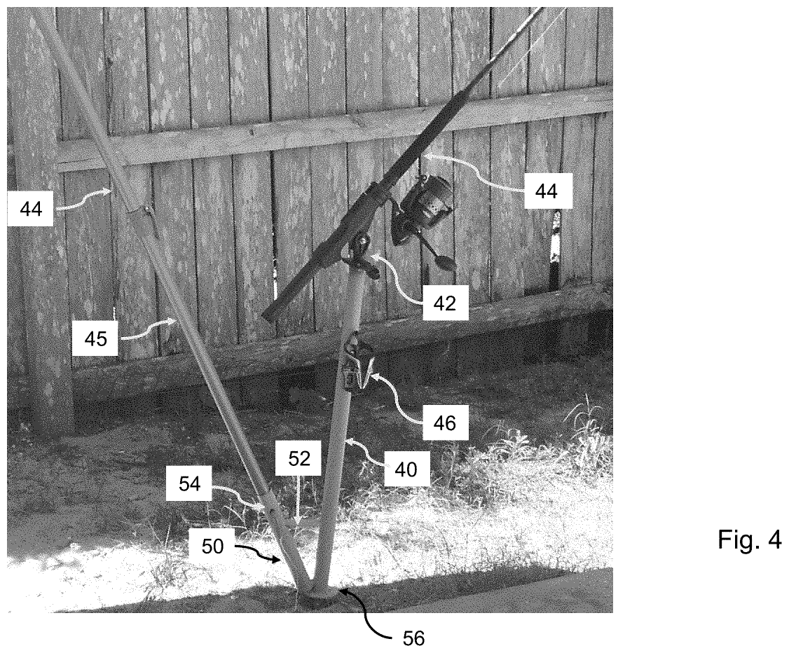

The fishing rod holder and support device of FIGS. 3-5 further comprises at least one accessory holder 46. The accessory holder 46 of FIG. 4 comprises a cup or drink holder secured to the main body portion 40. In addition to or in lieu of a drink holder, the accessory holder 46 may comprise a generic storage volume secured to the main body portion 40. The generic storage volume may comprise dedicated space to receive and store tools, fishing tackle, electronics, keys, and various personal articles. In some embodiments, the fishing rod holder and support device is contemplated as comprising solar panels to provide an electrical power source to charge electronic devices.

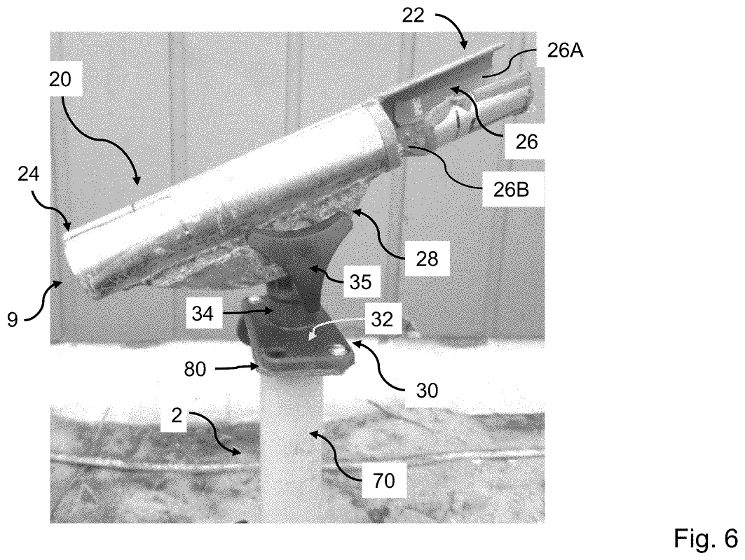

FIGS. 6-8 are perspective views of an adjustable rod holder 20 according to one embodiment of the present disclosure. As shown, the adjustable rod holder 20 comprises a first end 22 and a second end, and the first end comprises a slot 26 for selectively receiving a fishing rod or similar article. The slot 26 can be L-shaped with a longitudinal trunk 26A and a transverse base 26B.

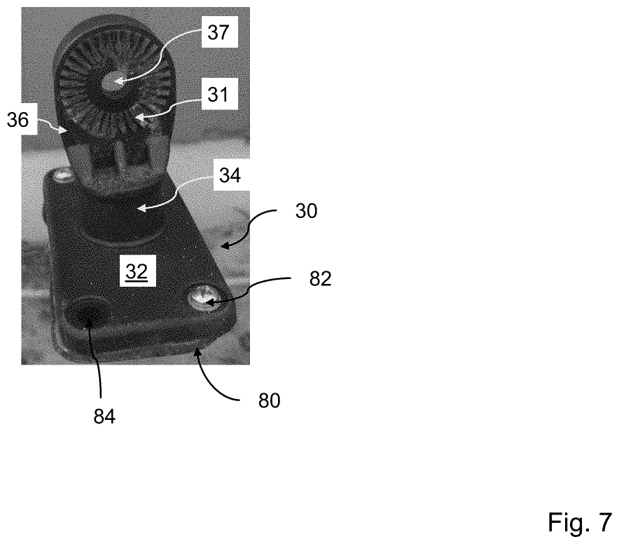

The adjustable rod holder 20 further comprises an arcuate mounting plate 28 which is received by a clamp member 30. The clamp member 30 is selectively received within a main body portion 70 of a rod holder and support 2. The clamp 30 comprises a toothed or rasped structure 31 (shown inf FIG. 7) for selectively receiving and securing the adjustable rod holder 20 in a plurality of angular positions relative to the main body portion 70.

FIG. 7 depicts the base portion or flange 32 of a clamp member 30 that is secured to a plate 80 at an upper end of the main body portion 70. The flange 32 of the clamp member 30 can optionally be secured to the plate 80 via fasteners 82 and apertures 84 provided in the base portion. In one embodiment, a projection 34 extends from the flange 32 and includes a planar surface 36. An aperture 37 for a bolt 35 extends through the planar surface 36. A toothed or rasped portion 31 is provided on the planar surface 36 to secure a fishing rod (for example) at various angular positions. The toothed structure 31 can be formed radially around the aperture 37.

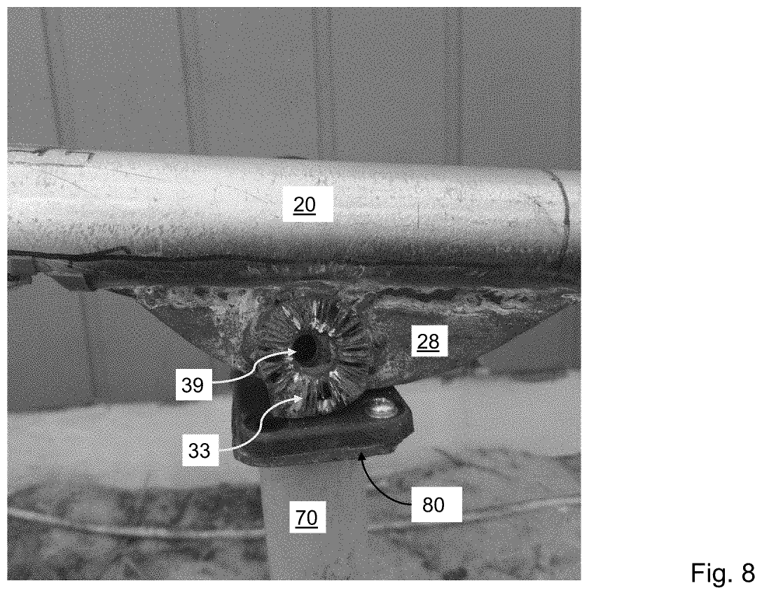

As shown in FIG. 8, a second toothed or rasped portion 33 is provided and secured to the arcuate plate 28 of the rod holder 20. An aperture or hole 39 can be formed through the arcuate plate 28 and concentrically aligned with the toothed portion 33. A bolt or similar fastener (35 in FIG. 6) is provided to secure the two rasped members 31, 33 together in a desired position.

Referring now to FIGS. 9-10, another embodiment of a rod holder and support device 2 of the present disclosure is generally illustrated. The rod holder and support device includes many of the same, or similar, features as the rod holder and support device described in conjunction with FIGS. 3-5. More specifically, the rod holder and support device can include a main body portion 40, a second support member 50 and a base plate 56. An umbrella 44 or an adjustable rod holder 42 (illustrated in FIG. 4) may be interconnected to either the main body portion 40 or the second support member 50. An umbrella 44 is interconnected to the main body portion 40 in the embodiment illustrated in FIG. 9.

An umbrella 44 or an adjustable rod holder secured to the main body portion 40 can be swiveled with respect to the rod holder and support device. More specifically, a plurality of apertures 54 can be formed around the circumference of the main body portion 40. A pin 55 or similar connector can be inserted through a first aperture. Optionally, the pin 55 can pass through the main body portion 40 and out of a second aperture to interconnect an umbrella 44, an adjustable rod holder, and similar devices to the main body portion 40. In this manner, the umbrella or adjustable rod holder can be rotated or swiveled relative to the base plate 56.

The rod holder and support device 2 includes an anchor 60 extending from the base plate 56 at the second end. In one embodiment the anchor 60 extends from a user-interface 57. The user-interface 57 can optionally be rotatable relative to the main body portion 40. For example, a projection (not illustrated) extending from the user-interface 57 can be received within a hollow interior of the main body portion 40. The projection can have a generally cylindrical shape such that the main body portion can rotate around the longitudinal axis of the body. A pin can be positioned in an aperture of the main body portion 40 to fix the projection of the user-interface 57 to the main body portion 40 at a desired orientation. The pin and aperture can be similar or the same as the pin 55 and aperture 54 illustrated in FIG. 9 for securing the umbrella 44.

The user-interface 57 may include a plurality of projections 58. Optionally, three projections 58 extend from the base plate. The user can apply force to the user-interface 57 to insert anchors 60 into the ground. One or more of the projections 58 can extend outwardly from a longitudinal axis of the main body portion 40. The projections 58 can optionally be substantially perpendicular to the axis of the main body portion. Additionally, one of the projection 58A can extend from the main body portion within a plane defined by a second support member 50. In this manner, the projection 58A can prevent inadvertent or unintended movement (or tipping) of the support device when a force is applied to a fishing rod or umbrella associated with the second support member 50. For example, the projection 58A can prevent rotation or pivoting of the rod holder and support device in the direction of the second support member 50 when a fish pulls on a line extending from a fishing rod secured to the second support member.

In one embodiment, two or more anchors 60A, 60B extend from the base plate 56. At least one of the anchors 60A, 60B can be offset from the longitudinal axis of the main body portion 40. Optionally, at least one of the anchors 60A, 60B is generally parallel to the longitudinal axis of the main body portion 40. In one embodiment, an anchor 60 can extend from each of the projections 58. Alternatively, in one embodiment, the projection 58A does not include an anchor.

Various dimensions are provided in the drawings. These dimensions are provided to illustrate certain contemplated dimensions of certain embodiments, and no limitation with respect to size or proportions is provided herewith. In some embodiments, for example, the main body portion 6 of the rod holder has a diameter of approximately 1.50 inches, and the secondary support member 8 comprises a diameter that is approximately 1.50 inches.

Devices of the present disclosure are contemplated as being comprised of a ferrous metal, but other materials including but not limited to various plastics are also contemplated. In various embodiments, it is contemplated that the devices are provided with a weight that is less than 10 pounds. Base plates of the present disclosure are contemplated as comprising a 0.50 inch thick and 3.50 inch wide plate welded to the rod holder and to the umbrella holder 4.0 inches below the top of the secondary support member. In some embodiments, the secondary support member 8 extends from the main body portion 6 at an angle of between approximately 15 and 60 degrees, and preferably at about 27 degrees. The adjustable rod holder of various embodiments provides for angular adjustability of a fishing rod between approximately 0 and 80 degrees relative to horizontal. In some embodiments, a secondary support for an umbrella or similar article is provided that is angularly adjustable such that the umbrella (or similar) can be provided at different angles relative to the main portion and/or fishing rod.

While the present invention has been illustrated by description of preferred embodiments and while the illustrative versions have been described in considerable detail, it is not the intention of the inventors to restrict or in any way limit the scope of the appended claims to such detail.

Additional advantages and modifications will readily appear to those skilled in the art upon reading this detailed description. Therefore, the invention, in its broader aspects, is not limited to these specific details, respective apparatus and methods, and illustrative examples shown and described. Accordingly, departures may be made from such details without departing from the spirit or scope of the inventor's general inventive concepts.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

To provide additional background, context, and to further satisfy the written description requirements of 35 U.S.C. § 112, the following references are incorporated by reference herein in their entireties: U.S. Pat. No. 2,954,909; U.S. Pat. No. 4,177,595; U.S. Pat. No. 4,293,113; U.S. Pat. No. 4,528,768; U.S. Pat. No. 6,490,823; U.S. Pat. No. 7,520,485; U.S. Pat. No. 7,559,171; U.S. Pat. No. 8,024,886; U.S. Pat. No. 8,156,681; and U.S. Pat. No. 8,276,310.

What is claimed is:

1. A fishing rod holder and support device comprising:
a main body portion having an upper end, a lower end, and a length extending therebetween;
the upper end comprising an aperture for receiving at least one of a fishing rod and an adjustable fishing rod holder;
the lower end comprising a base plate;
an anchor member extending from the base plate, and wherein the anchor member is operable to penetrate a ground surface comprising at least one of soil and sand;
a secondary support member extending at an angle relative to the main body portion, the secondary support member operable to receive an elongate device; and
at least one storage compartment mounted to the main body portion, the at least one storage compartment operable to receive at least one of a beverage container, an electronic device, and a personal article.

2. The device of claim 1, wherein the main body portion is configured to facilitate rotation of the fishing rod or the adjustable fishing rod holder.

3. The device of claim 1, wherein the main body portion comprises a plurality of apertures formed transverse to the length.

4. The device of claim 1, wherein the anchor member comprises two or more anchor members extending from the base plate.

5. The device of claim 1, wherein the base plate is rotatable relative to the anchor member.

6. The device of claim 1, wherein the base plate includes a plurality of projections which extend generally perpendicular to main body portion.

7. The device of claim 1, wherein the secondary support member comprises a bore to receive the elongate device and apertures to pin the elongate device in the bore, and wherein the secondary support member is affixed to the base plate and the main body portion at an angle of between about 15° and 60°.

8. The device of claim 7, further comprising an angle iron with a first end fixed to the main body portion and a second end fixed to the secondary support member.

9. The device of claim 1, wherein the adjustable fishing rod holder has a cylindrical body, a bore extending through the body, and a slot to engage the fishing rod formed through an upper end of the cylindrical body, the slot including a longitudinal trunk and a transverse base.

10. The device of claim 9, wherein the adjustable fishing rod holder further includes an arcuate plate extending from the cylindrical body and including a plurality of teeth, the teeth configured to engage a toothed structure of a clamping element affixed to the upper end of the main body portion.

11. A holder for a fishing rod and an umbrella, comprising:
a base plate;
a first anchor extending downwardly away from the base plate;
a main body extending upwardly from the base plate, the main body including an upper end with a mounting plate;
a clamping member with a flange secured to the mounting plate, a projection extending upwardly from the flange and including a planar surface, an aperture extending through the planar surface, and a plurality of teeth extending radially around the aperture;
a rod holder including a cylindrical body, a bore extending through the cylindrical body, a slot to engage the fishing rod formed through an upper end of the cylindrical body, and an arcuate plate extending from the cylindrical body, the arcuate plate including a hole and a toothed structure formed around the hole, wherein the rod holder is rotatably secured to the clamping member by a bolt that extends through the plate hole and the projection aperture such that the teeth engage the toothed structure; and
a secondary member affixed to the base plate and oriented at an oblique angle to the main body, the secondary member including an upper end with an opening to a bore configured to receive a shaft of the umbrella.

12. The holder of claim 11, further comprising an accessory holder affixed to the main body, the accessory holder configured to receive at least one of a beverage container and an electronic device.

13. The holder of claim 11, further comprising a user interface connected to the holder proximate to the base plate, the user interface including a first projection, a second projection opposite the first projection, and a third projection, the projections oriented approximately perpendicular to the main body.

14. The holder of claim 13, wherein the first anchor extends downwardly from the first projection and a second anchor extends downwardly from at least one of the second and third projections.

15. The holder of claim 13, wherein the projections of the user interface are generally planar.

16. The holder of claim 13, wherein the user interface is rotatable relative to the base plate and the main body.

17. The holder of claim 11, wherein the clamping member is secured to the mounting plate by at least two fasteners that extend through apertures of the clamping member flange and the mounting plate.

18. The holder of claim 11, wherein the cylindrical body of the rod holder can be oriented at an angle of 0° and approximately 80° relative to the main body.

19. The holder of claim 11, wherein the oblique angle between the secondary member and the main body is between approximately 20° and approximately 40°.
